(19) United States
(12) Patent Application Publication
(10) Pub. No.: US 2015/0311497 A1
(43) Pub. Date: Oct. 29, 2015

(54) METHOD FOR PRODUCING AT LEAST ONE LAYER OF A SOLID -BASED THIN-FILM BATTERY, PLASMA POWDER SPRAYER THEREFOR, AND SOLID-BASED THIN FILM BATTERY

(71) Applicant: Maschinenfabrik Reinhausen GmbH, Regensburg (DE)

(72) Inventors: Stefan Nettesheim, Berlin (DE); Dariusz Korzec, Wenzenbach (DE); Klaus Forster, Bad Abbach (DE)

(21) Appl. No.: 14/793,113

(22) Filed: Jul. 7, 2015

Related U.S. Application Data
(63) Continuation of application No. PCT/IB2013/061225, filed on Dec. 20, 2013.

(30) Foreign Application Priority Data
Jan. 7, 2013 (DE) 102013100084.3

(51) Int. Cl. H01M 4/04; C23C 4/10; C23C 4/12; H01M 10/052; H01M 10/0562

(52) U.S. Cl. CPC H01M 4/0419; H01M 10/052; H01M 10/0562; C23C 4/127; C23C 4/105

(57) ABSTRACT

A method for the manufacture of a layer for solid state thin-film batteries using a plasma-powder-sprayer with a plasma generation area and a mixing area spatially separated from it, including creation of a plasma gas stream from an ignition gas stream in the plasma generation area; creation of a powder-aerosol stream from a carrier gas stream from a carrier gas reservoir and powder particles from a powder reservoir, wherein the powder particles are extracted in a particular way; introduction of the powder-aerosol stream and the plasma gas stream into the mixing area, so that a plasma-powder-aerosol is formed; directing a plasma-powder-aerosol stream from the mixing area onto a substrate arranged in a coating area; and, deposition of a layer on a substrate of powder particles that are superficially fused or changed in their crystalline structure in the mixing area and/or in the plasma-powder-aerosol stream and/or in the coating area.

### CROSS-REFERENCE TO RELATED APPLICATIONS

This application is filed under 35 U.S.C. §111(a) and §365(c) as a continuation of International Patent Application No. PCT/IB2013/061225, filed Dec. 20, 2013, which application claims priority from German Patent Application No. 10 2013 100 084.3, filed Jan. 7, 2013, which applications are incorporated herein by reference in their entirety.

### FIELD OF THE INVENTION

The present invention concerns a procedure for the manufacture of at least one layer for solid state thin-film batteries by plasma powder spraying. Furthermore, the present invention concerns a plasma-powder-sprayer for the manufacture of at least one layer for solid state batteries onto a substrate. The plasma-powder-sprayer comprises a plasma generation area, in which a plasma gas stream can be generated with the help of an energy source, and at least one mixing area that is located in the plasma gas stream. The present invention also includes a solid state battery manufactured by a procedure in accordance with the invention.

### BACKGROUND OF THE INVENTION

Solid state batteries, in a multitude of applications, can satisfy the requirements for high-performance, cheap, safe, primary and secondary batteries that can be integrated in existing products. They distinguish themselves by high cycle stability, low self-discharge, safety and low toxicity. Increasing miniaturization requires even smaller batteries with more flexible architecture and at the same time higher volumetric or specific power density. Solid state batteries can, for instance, be used in autonomous microsystems such as microelectromechanical systems (MEMS), electronic parts through RFID tags, various wireless sensors, smart credit cards, portable electrical devices, functionalized apparel and even electro mobility applications.

A typical solid state thin-film battery stores energy chemically, preferably in low-order alkali metals such as lithium or sodium. The energy stored chemically in, for instance lithium (Li), can be utilized as electrical energy through an exothermic oxidation to a Li⁺-anion:

Li⇄Li⁺+e⁻

A solid state thin-film battery consists of a cathode and an anode that are physically separated by an electrolyte. During the charging or discharging a solid state thin-film battery, there are always two opposing currents flowing against each other, one current of ions and an electrical compensating current for the charge balance. The electrical power emanating from this compensating current and the battery voltage can be used by a consumer. The electrolyte is conducting with respect to the ion current and insulating with respect to the current of electrons. As a result, an electron current can flow only if the anode and the cathode are electrically connected. If no electron current can flow, the ion current coulomb is suppressed, so that the energy remains chemically stored.

During the discharge process, the Li in the anode is oxidized to Li⁺. If there is an electrochemical potential difference from the anode to the cathode, the ions diffuse into the cathode. During the charging process, the process runs in the opposite direction. The ions that diffuse into the cathode are intercalated in the cathode material during the charging process and accordingly de-intercalated during the discharging process. A suitable intercalating material consists, for instance, of crystalline layers of an oxide of transition metals like lithated cobalt dioxide (LiCoO₂).

The following reactions take place in a LiCoO₂ cathode during the charging and discharging processes, whereby the roman figures indicate the level of oxidation:

Li^{+I}Co^{+III}O₂^{-II}⇄Li₁₋ₓ^{+I}Co₁₋ₓ^{+III}Coₓ^{-II}+xLi^{+I}+xe^{-I},

To increase the volumetric or specific storage capacity (measured as Wh/ccm or Wh/g), the volume of the cathode layer can be increased. Since the projected basic surface area of the thin-film battery is usually specified by its application, the cathode volume per layer system consisting of cathode, electrolyte and anode can be increased only through the thickness of the film. On the other hand, the electrical and ion conductivity of the layer system reduces with increasing thickness of the cathode layer. The cathode layer and also the electrolyte layer must therefore be made as thin as possible and also free of defective spots. The thinner the layer thickness and the larger the interface between cathode and electrolyte as well as between the electrolyte and the anode, the better is the ion conductivity of the layer system.

Carrying out all the production stages of a thin-film battery on a continuously running production band during the automated series production is recommended. Consequently, the slowest sub-process determines the cycle time of the production. Production costs correlate directly with the production cycle time. The coating process of the cathode is often a restricting factor for the production cycle time.

One requirement for rechargeable secondary batteries is that the ability for intercalation of the cathode material is retained over many intercalation and de-intercalation cycles and that it withstands the mechanical stress in conjunction with it. The electrochemical properties of a cathode layer are mainly determined by their crystalline structure, chemical stoichiometry, morphology, such as crystallinity, particle size distribution and the porosity of the layer.

In U.S. Pat. No. 5,612,152, a rechargeable solid state multi-cell battery has been revealed. The individual cells consist of a cathode layer made of a lithium intercalation material, an electrolyte layer of lithium-phosphorus-oxynitride (LIPON) and an anode layer of lithium. Batteries with different battery amperages, voltages and capacities can be manufactured by structuring and connecting several cells in series or parallel. The energy content of the battery can also be raised by the thickness of the cathode and anode layers.

U.S. Pat. No. 5,445,906 describes a method and a system for the manufacture of a thin-film battery. A net-like substrate is automatically passed through a multitude of coating stations. In the coating stations, the layers are successively coated on the substrate in a layer sequence typical for solid state thin-film batteries. Masks can be used for structuring the layers. In particular, the battery coated net-substrate can be rolled up. Preferably, the net-substrate is arranged on a conveyor belt. To ensure that the conveyor belt can move continuously during the coating process, the length of the individual coating stations is matched to the relevant layer.

In German patent specification DE 100 53 733 B4, a procedure for crystallization of a thin-film from a lithium-transition metal oxide has been suggested. In the first step, a thin-film of a lithium-transition metal oxide is vapor-deposited on a substrate, e.g., with the help of a HF-magnetron sputter source. In the subsequent step, the thin-film is post-treated with an oxygen or inert gas plasma to increase the degree of crystallization, the surface smoothness and electrochemical resistivity of the thin-film material.

The translation DE 601 26 779 T2 of the patent specification EP 1 305 838 B1 describes a thin-film energy storage device on a substrate with a melting, or decomposition temperature under 300° C. as well as a procedure for its manufacture. Different materials such as LIPON or lithium intercalation materials from one or more DC-magnetron sputter sources can be deposited on the substrate. Likewise, one or more auxiliary sources can be directed onto the substrate and the material layer can be impinged with force with energized auxiliary materials so that the crystal growth with regard to crystallite size and crystal orientation can be controlled.

French patent application FR 2 729 400 reveals a plasma supported process for depositing a thin metal oxide layer, the material so obtained and a battery with this material. To improve the porosity and composition of the deposited material as well as its adhesion on a substrate, a metal is injected not as a powder but as an aqueous solution in a plasma generator. The metal particles oxidize due to high oxygen content in the plasma.

International patent application WO 2009/033522 A1 reveals a procedure and a device for the treatment or coating of surfaces with a plasma jet. The plasma jet is created in one or more plasma generators and injected into one or more reaction chambers connected to the plasma generator and thoroughly mixed with an aerosol. The plasma activated aerosol is deposited onto a substrate. To avoid damaging the substrate by undesired plasma induced physical or chemical processes, the plasma jet is injected into the reaction chamber in such a way that no plasma comes out of the reaction chamber and thus the direct contact of plasma with the substrate is avoided.

In the patent application U.S. 2011/0045206 A1, a procedure and a device for the manufacture of an electrochemical layer of a thin-film battery is revealed. A dispenser is arranged in a process chamber. Plasma is ignited from a precursor mixture in an activation chamber of the dispenser. The precursor mixture consists of a solution, suspension or slurry of precursor particles in a fluid carrier medium. The precursor mixture can contain in particular, cobalt, nickel, magnesium, their nitrates or lithium. The plasmafied precursor mixture is mixed in a mixing area with oxygen and a combustible gas that adds additional thermal energy to the precursor particles. The precursor mixture and oxygen react in a reaction chamber to form electrochemically active nanocrystals that are deposited on a substrate. In particular, the admixture of a carbonaceous gas is intended for wrapping the nanocrystals with carbon. Furthermore, a polymer binding agent is fed to the gas stream which contains the nanocrystals so as to create a layer of nanocrystals and polymer binding agent.

A disadvantage of the state-of-the-art is the typically restricted rate of deposition. Methods such as physical vapor phase deposition (PVD), thermal vapor deposition or sputtering deliver deposition rates of just a few nm/s and require sophisticated vacuum units with a basal pressure under 10⁻⁴ mbar or preferably even under <10⁻⁶ mbar. In particular, the cathode material is manufactured by chemical reaction first in the manufacturing process or taken from a solid target. Such deposition techniques restrict the speed of the process or are unsafe with respect to the achieved layer stoichiometry and morphology. Especially, in the case of stacked batteries, the insufficient reproducibility of the layer properties is a disadvantage and increases production rejects.

### BRIEF SUMMARY OF THE INVENTION

The primary object of the present invention is to create a procedure for the manufacture of thinner and mechanically more stable layers for solid state thin-film batteries that can be integrated into a production process quickly, cost-effectively, simply, reliably, flexibly and one that is capable of automation.

Another object of the present invention is to create a plasma-powder-sprayer for manufacturing thinner layers for solid state thin-film batteries, with which one can manufacture the layers for a solid state thin-film battery quickly, cost-effectively, reliably and in a procedure that can be automated.

Likewise it is an object of the present invention to create a long-term high-performance solid state thin-film battery that is, mechanically stable and simple and cost effective to manufacture.

Another object of the present invention serves the manufacture of at least one layer for solid state thin-film batteries or super condensers. Layer types that can be manufactured according to the present invention can include the current collectors, the anode, the cathode, the electrolyte, the electronic separator or a protective outer coating. Several of the layers of the same type of layer can be manufactured in thin-film batteries in accordance with the present invention. The layers manufactured in accordance with the present invention comprises powder particles that have been prepared or electrochemically activated with the help of a plasma-powder-sprayer and deposited on a substrate. The plasma-powder-sprayer comprises a plasma generation area and at least one mixing area spatially separated from it.

At first an ignition gas is fed into the plasma generation area. A plasma gas stream is created out of the ignition gas stream by bombarding with energy. In accordance with the present invention, the ignition gas stream consists of gaseous raw materials, however not liquid or solid raw materials.

Furthermore, a powder-aerosol stream is created. A powder-aerosol in accordance with the present invention comprises exclusively powder particles of solid aggregate status dispersed in a carrier gas. The powder-aerosol stream can be created in a preferred manner in which carrier gas from a carrier gas reservoir streams into a power reservoir and carries along powder particles contained in it. The powder-aerosol stream is taken from the powder reservoir, for example over a powder-aerosol supply line that is under low pressure relative to it, and fed to at least one of the mixing areas. Furthermore, the plasma stream from the plasma generation area is fed into this mixing area. Due to that, the plasma gas stream and the powder-aerosol stream mix with each other, so that a plasma-powder-aerosol is created.

The plasma-powder-aerosol is channeled out in a stream from at least one mixing area and directed at a substrate that is arranged in a coating area. The powder particles dispersed in the plasma-powder-aerosol stream are deposited as a layer on the substrate in the coating area. The powder particles are modified under the effect of the plasma.

In particular, powder particles can be withdrawn in precise doses under the admixing of carrier gas in such a manner, that a constant mass flow of powder particles dM/dt and a constant mix ratio of powder particles and carrier gas is set, where M is the mass of powder particles transported in the powder-aerosol stream and t is the time. The powder-aerosol stream is kept constant, at least over a withdrawal period that lies within the typical time scale of the coating process. Alternatively, any target mass flow profiles dM/dt(t) and/or mixing ratios between carrier gas and powder particles in the powder-aerosol stream across the extraction time period can be adjusted in a controlled manner.

Furthermore, the method can channel the powder-aerosol stream through a device that brings it to a temperature required for running the process. The substrate may also be heated by a substrate heater.

The method of the present invention can also utilize an adjusting system to move the plasma-powder-sprayer and/or the substrate or the substrate holder. Such a relative movement so effected between plasma-powder-sprayer and substrate can take place in one or all three spatial dimensions and include tilting relative to one or both spatial angles. In this way, the plasma-powder-sprayer can track over and coat the surface of substrates of any two or three dimensional topography along any trajectory. Also, the angle of incidence of the plasma-powder-aerosol stream relative to the surface can be set so as to extensively coat, for instance, depressions in the substrate. In particular, the distance between the plasma-powder-sprayer and the substrate can be set. This distance is determined by the softening of the plasma-powder-aerosol stream, the size of the coating area, the heat flow per unit area carried by it to the substrate per unit area and the rate of coating or a gradient of the rate of coating over the coating area.

For example, a flat substrate can coat the whole or part of the area along a meandering or spiral trajectory by a relative movement of the plasma-powder-sprayer. By adjusting the trajectories and/or by interruption of the supply of power particles, layers of any shape can also be coated. In addition, a static or structural element that can likewise be adjusted by an adjusting system can be introduced into the plasma-powder-aerosol stream on or over the substrate, so as to structure the deposited layer. The structuring element can be a screen over, or a mask on, the substrate or can be created by lithographic methods.

The method of the present invention can also be carried out in a coating chamber in which the substrate has been introduced. For this, the plasma-powder-sprayer can be arranged inside or outside the coating chamber and can be connected to it in a fluid manner. This way the coating process can be carried out under an inert gas atmosphere. In particular, a negative pressure can be created in the coating chamber with the help of a suction pump so that the coating takes place under low pressure or vacuum conditions.

In another object of the method of the present invention, one auxiliary material each can be introduced in at least one mixing area. An auxiliary material and/or a powder-aerosol stream can be introduced in at least one more mixing area. Thus, different mixing areas can be fed with different materials. At least one more mixing area lies in the plasma-powder-aerosol stream and can lie inside or outside the plasma-powder-sprayer. The auxiliary material can, for example, be a carbonaceous gas for plasma supported vapor deposition of carbon or other powder-aerosol whose powder particles have a different chemical, electrochemical or structural composition than the powder particles introduced into the first mixing area. The powder particles introduced into the first mixing area can be partly or wholly coated or fully wrapped up with one or several auxiliary materials. The process conditions in the mixing areas can, for example, be set by the plasma properties, the temperature and/or the pressure or partial pressure conditions.

For the manufacture of an anode or cathode layer of a solid state thin-film battery, the powder particles, in accordance with the present invention, consist of an intercalation material suitable for the embedding of ions. Preferably, the solid state thin-film battery is based on the intercalation of alkali metals such as lithium ions. The powder particles consist, e.g., of a lithated oxide of one or several transition metals.

According to another method of the present invention, the powder particles from which the layer will be built up are thermally activated in the plasma-powder-aerosol stream. Furthermore, the powder particles in the plasma-powder-aerosol are not altered with respect to their chemical stoichiometry and their particle size distribution. Due to the particle size distribution the particle stream contains solid and melted portions that solidify abruptly on hitting the substrate and thus create a firm bond. The porosity of the layer is essentially determined by the particle size distribution of the particles as well as its temperature and pressure dependent diffusibility on the substrate. The diffusibility can be set, e.g., by the rate of deposition, the substrate temperature or the impact velocity of the powder particles on the substrate. The higher the substrate temperature or the impact velocity and the lower the rate of deposition, the more time remains for the rearrangement of the powder particles on the substrate and the more dense the layer tends to be. The porosity of the layer can reduce the mechanical stress that occurs for instance during the intercalation and de-intercalation cycles of ions in a cathode layer. Furthermore, it can increase the ion conductivity of the battery by increasing the effective surface area.

The ignition gas stream and/or the carrier gas stream consists preferably under process conditions of one or more chemically inert gases such as argon or nitrogen. Additionally, partial streams of oxygen, hydrogen and/or a carbonaceous gas metered through flow controllers can be admixed. Hydrogen can, for example, function as a reduction agent. In accordance with the present invention, the plasma-powder-aerosol stream is additionally heated by the controlled oxidation of combustible gases such as hydrogen or the carbonaceous gases. In a typical forming gas consisting of nitrogen and hydrogen in accordance with the present invention, the hydrogen portion usually lays less than 10 weight percent of the total gas stream, preferably however between 3 and 7 weight percent. Correspondingly, the flow rates of, e.g., nitrogen and hydrogen, each lie in the range of 10-25 sccm. Typically the set total pressure, at least in one mixing area, lays around 0.5-2.5 bar.

In another object of the present invention, the powder particles can be thermally activated with respect to their electrochemical properties. For that the temperature in the plasma-powder-aerosol stream is set for instance by modulation of the coupled energy in the plasma generation area, the total pressure and the ratios of the partial pressures of the gases contained therein. Furthermore, the temperature can be influenced by the substrate heater or the device for the temperature control of the plasma-power-aerosol. In accordance with the present invention, different temperatures and partial pressures can thus be set in different mixing areas. At the same time, the chemical stoichiometry or the chemical stoichiometric ratio of oxidic powder particles such as LiₓCoO₂ by admixing of oxygen, can be obtained in an atmosphere with excess oxygen. Oxygenic defects in LiₓCoO₂-powder particles reduce the ion conductivity and ability for intercalation of lithium ions and as a result the battery power.

In an embodiment of the method of the present invention, the powder particles of lithium cobalt dioxide are thermally altered in the HT-phase. Additionally a mixing temperature in the region of 350° C. to 750° C. is set in at least one mixing area. For setting the mean heat input per powder particle and the chemical stoichiometry of the powder particles, the total pressure as well as the partial pressures are matched to the mixing temperature. The ratio of mixing temperature to the partial pressure of oxygen is particularly essential for achieving a high portion of defect-free lithium cobalt dioxide in the HT-phase. At the same time, the substrate temperature is maintained under 240° C., for instance at 200° C.

The present invention further includes a plasma-powder-sprayer for the manufacture of at least one layer on the substrate for solid state thin-film batteries. It includes a plasma generation area and an energy source for generation of a plasma stream as well as at least one mixing area that lies within the plasma gas stream. In accordance with the present invention, the plasma generation area is thus spatially separated from at least one mixing area. In particular, with the plasma-powder-sprayer in accordance with the present invention, only one ignition gas stream can be introduced into the plasma generation area. Consequently, plasma is exclusively ignited from the ignition gas stream. The plasma gas stream thus obtained flows from the plasma generation area to at least one mixing area. One powder-aerosol stream can be introduced through at least one powder-aerosol supply line to at least one mixing area. The plasma gas stream and the powder-aerosol stream mix with each other to a plasma-powder-aerosol stream in at least one mixing area. Particularly, no powder-aerosol enters the plasma generation area. Thus abrasive or conductive powders can also be processed in the plasma-powder-sprayer without soiling, damaging or electrically short-circuiting it.

In an embodiment of the present invention, at least one powder-aerosol supply line can be assigned one device for setting a temperature of the powder-aerosol stream. Similarly, the substrate can be arranged opposite the plasma-powder-sprayer on a substrate holder with a substrate heater for setting the substrate temperature.

Furthermore, the plasma-powder-sprayer can be assigned an adjustment system for generation a relative movement between the plasma-powder-sprayer and the substrate holder.

In a preferred embodiment of the present invention, at least one mixing area includes a first mixing area and at least a second mixing area that are arranged spatially separated from each other and within the plasma-powder-sprayer. Additionally, at least one second mixing area can include at least another mixing area that is arranged outside the plasma-powder-sprayer. Furthermore, an auxiliary material can be introduced into each mixing area through the at least one powder-aerosol supply line.

The present invention further includes a solid state thin-film battery in which at least one layer is manufactured from powder particles by a novel process. Particularly, in accordance with the present invention, mechanically stable and electrochemically active layers with respect to their electrochemical properties can be manufactured from activated powder particles and without using additives, e.g., binding agents. Similarly, one can do away with auxiliary materials that are potential contaminants for the layers.

The cathode layer can, for example, consist of LiₓCoO₂, LiNiₓCo_{1-x-y}Mn_{y}0₂, LiₓFePO₄, LiₓMn₂O₄, LiₓNiO₂, LiₓNiCoO₂, Li₂FeSiO₄, Li₂MnSiO₄, or Li₂VOSiO₄, TiS₂, TiOS or Na₅V₂(PO₄)₂F₃. The method of the present invention is preferably run in such a way that the lithium content x of the lithium embedded in the intercalation material does not fall below the stability range. If the lithium content falls below the stability range, the intercalation ability of the intercalation material is irreversibly reduced and as a consequence of this also the capacitance of the thin-film battery. In case of LiₓCoO₂ the stability range lies, e.g., at 0.5<x=<1. Furthermore, powder particles with a special electrochemically advantageous crystalline structure can be used. For instance, powder particles in the powder reservoir of LiₓCoO₂-crystallites can exist in the HT-phase. On the basis of its rhombohedral structure, HT-LiₓCoO₂ has a particularly favorable intercalation kinetic for the conduction and storage of lithium ions. A particular advantage of the procedure is that the powder particles with regard to their particle size distribution can be pre-selected and checked for quality and if need be reselected before they are essentially deposited as a layer without change in particle size distribution or stoichiometry. In this way the production rejection can be reduced.

The anode layers in accordance with the present invention can consist of the same material as the cathode layers or can consist of pure lithium. Cathode and/or anode layers can further include a matrix. A matrix such as this can stabilize the anode layer that is stressed by intercalation cycles or increase its electrical and/or ion conductivity. The matrix can for example consist of polymers, graphite, buckyballs, carbon nanotubes, lithium titanate, silicon and/or tin.

The electrolyte layer can consist of amorphous lithium phosphorous oxide nitride (LiₓPO_{y}N₂ or “LIPON”). It can be manufactured by a procedure in accordance with the present invention directly from LIPON powder particles. Alternatively, the electrode material can be synthesized by a reaction of, e.g., or from, e.g., lithium phosphate in a nitrogenous plasma gas stream. The use of a material such as LIPON that is conducting with respect to lithium ions and insulating with respect to electrons, makes an additional separator layer for electrical separation of cathode and anode unnecessary.

Furthermore, the cathode and anode layers of the thin-film battery can include current collectors. They can consist, e.g., of aluminum, copper, silver, nickel, nanowires, carbon nanotubes, graphite or conductive polymers. The cathode or anode layer can even themselves be designed as current collectors.

Due to the lower substrate temperature of 240° C. to under 90° C. when compared to other procedures, combined with mechanical stability and bonding strength of the deposited layers, the procedure in accordance with the present invention is suitable for a multitude of substrate materials such as stainless steel foils, mica, semiconductor wafers, glasses, polymer films textiles or paper. Furthermore, thin-film batteries in accordance with the present invention can be directly structured onto electronic printed circuit boards (PCB) or micromechanical system/(MEMS)-building blocks and can be electrically connected with these directly at the switching level. The procedure is also suitable for the manufacture of flexible thin-film batteries on flexible substrates.

The typical layer thicknesses of a thin-film battery in accordance with the present invention are between 1 μm and 500 μm for anode layers, typically however 10 μm to 100 μm, 0.1 μm to 10 μm for electrolyte layers, typically however 1 μm, and between 0.5 μm and 100 μm for current collectors, typically however 50 μm.

A particular advantage of the method of the present invention is its high rate of deposition when compared to state-of-the-art. Typical rates of deposition lie between 3 and 5 g/min or even 2-10 g/min. In relation to the layer thickness, typical rates of coating from 100 μm/s to a few 100 μm/s can be achieved. The feed rate of the relative motion between plasma-powder-sprayer and substrate for the deposition process is, e.g., 100 to 200 mm/s, at a gap in the range of 3-15 mm.

In another object of the present invention jets, or jets that can be dosed can be formed on the opening of the plasma-powder-sprayer, at the ignition gas inlet, between the plasma generation area and a mixing area and/or at the junctions of the powder-aerosol supply lines in a mixing area.

### BRIEF DESCRIPTION OF THE DRAWINGS

In the following paragraphs, embodiments of the procedure in accordance with the present invention and the device for the manufacture of at least one layer for solid state thin-film batteries in described in detail with the help of the attached drawings. These exemplarily concretized embodiments are not to be considered as limitations for the scope of the invention.

The invention is described in detail below with reference to the drawings, wherein:

FIG. 1 shows a schematic sectional view of a layer system of a solid state thin-film battery;

FIG. 2 shows a sectional view through an embodiment of a solid state thin-film battery with structured layer build-up;

FIG. 3 shows a schematic depiction of a procedure in accordance with the present invention for the manufacture of a layer for solid state thin-film batteries with the help of a plasma-powder-sprayer;

FIG. 4 shows a schematic sectional view of another embodiment of the plasma-powder-sprayer in accordance with the present invention;

FIG. 5 shows a schematic sectional view of another embodiment of the plasma-powder-sprayer in accordance with the present invention; and,

FIG. 6 shows a schematic sectional view of yet another embodiment of the plasma-powder-sprayer in accordance with the present invention.

### DETAILED DESCRIPTION OF THE INVENTION

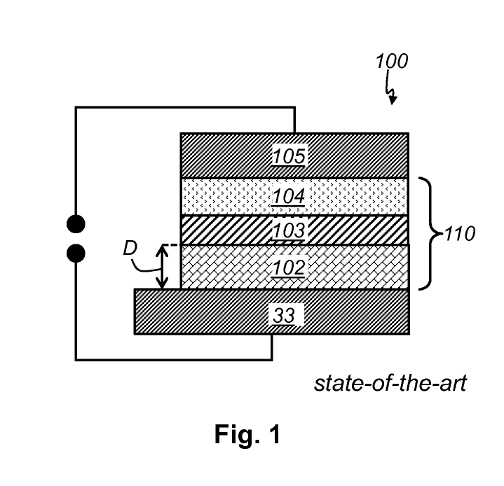

Identical reference numbers in the drawings refer to similar or identical structural elements of the invention. FIG. 1 shows the principal structure of a solid state thin-film battery 100 built up layer by layer as per the state-of-the-art. On a substrate 33, one cathode layer 102 followed by one electrolyte layer 103 and an anode layer 104 are deposited. The electrolyte layer is an ion conductor, so an ion current can flow between cathode layer 102 and anode layer 104. During the charging process of the solid state thin-film battery 100, the ion current causes an intercalation of ions in the cathode layer 102 and correspondingly their de-intercalation from the anode layer 104 or vice versa for the discharging process. At the same time, the electrolyte layer 103 is an insulator in relation to the conduction of electrons, so that it electrically separates the anode layer 102 and the cathode layer 104. An ion current is electrostatically suppressed if the anode layer 102 and the cathode layer 104 are electrically connected otherwise, so that an electric compensation current can flow for charge balancing. The electric power resulting from this compensation current and the battery voltage can be utilized by a consumer. For a preferably loss free absorption of this power, the anode layer 102 and cathode layer 104 can each be coated by an electrically conductive current collector 33 and 105 with low electrical boundary surface resistance. In FIG. 1, the substrate 33 itself functions as the current collector of the cathode layer 104.

The capacity of the solid state thin-film battery 100 can be increased in accordance with the present invention by increasing the volume of the cathode layer 102 with a larger layer thickness D. Technically, the layer thickness D is limited however by the mechanical stress, which accompanies the volume change of the intercalation material during intercalation and de-intercalation. Stability and lifespan of the solid state thin-film battery 100 can be increased by reducing the mechanical stress with a porous design of the cathode layer 102. For increasing the compensation current or the battery voltage, at least the ion conducting layer sequence 110 can be connected in parallel and/or in series.

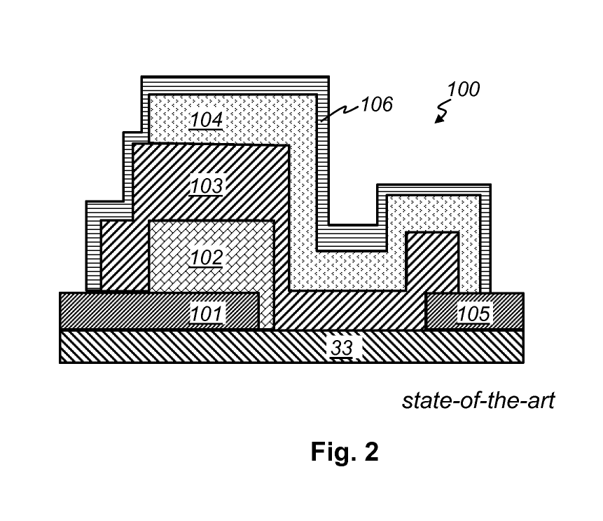

FIG. 2 shows a schematic sectional view through another embodiment of a solid state thin-film battery 100 with structured layer build-up. In this embodiment, a current collector 101 is provided on an electrically insulating substrate 33. The previously described layers 102, 103 and 104, with reference to FIG. 1, are covered over their whole surface by an electrically insulating protective layer 106. For the purposes of contacting, the surfaces of the collectors 101 and 105 are partly free. FIG. 2 shows that any two or three dimensional structured layers 32 of solid state thin-film batteries 100 can be manufactured by the procedure in accordance with the present invention. Likewise, substrates 33 with any three dimensional topography can be coated.

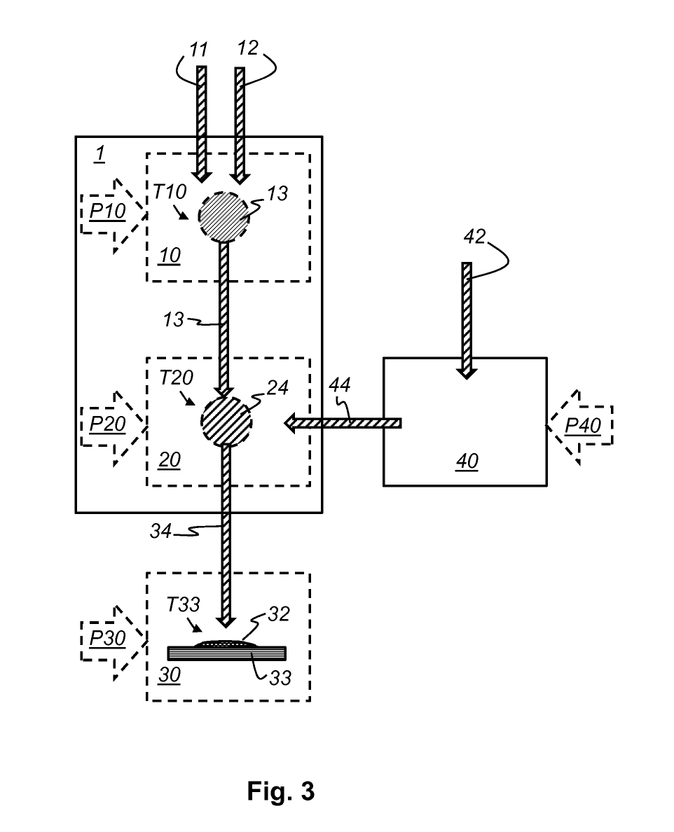

FIG. 3 shows a schematic depiction of a procedure in accordance with the present invention for the manufacture of at least one layer 32 for solid state thin-film batteries 100 with the help of a plasma-powder-sprayer 1. An ignition gas stream 12 is introduced into a plasma generation area 10 and bombarded with energy 11 so that a plasma gas stream 13 is ignited from the ignition gas stream 12. The plasma gas stream 13 flows into a mixing area 20 that is spatially separated from the plasma generation area 10. Furthermore, in a powder dosage unit 40 a powder-aerosol stream 44 is created from a powder 23 and a carrier gas 42 and dosed into the plasma gas stream 13 in the mixing area 20. Due to this, a plasma-powder-aerosol stream 34 is created, which is directed from the mixing area 20 onto a substrate 33 arranged in a coating area 30. Therefore a layer 32 of powder particles that can be modified in the plasma-powder-aerosol stream 34 is deposited on the substrate 33. During plasma ignition, high ignition temperatures T10 of up to 10,000 K can occur in the plasma generation area 10. As the mixing area 20 is spatially separated from the plasma generation area 10, a considerably lower mixing temperature T20 of under 1,000° C. can independently be set there. Analogous to this, a substrate temperature T33 can also be independently set. To prevent powder particles from entering the plasma generation area 10, a higher ignition pressure P10 than the mixing pressure P20 in the mixing area 20 can be set there. To ensure that the streams flow as described earlier, the mixing pressure P20 must be set lower or higher than the dosing pressure P40 in the powder dosing unit 40 or the coating pressure P30 in the coating area 30. P10, P20, P30 and P40 are to be understood as static and/or dynamic pressures. The coated substrate 33 can be sintered, tempered or treated with plasma in a following step.

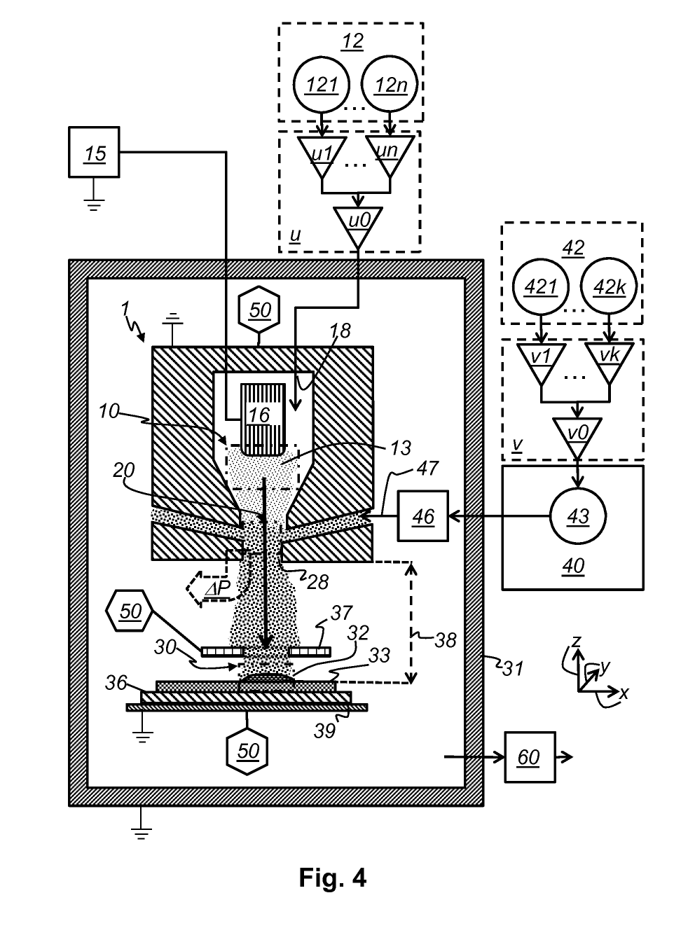

FIG. 4 shows a schematic sectional view of an embodiment of a plasma-powder-sprayer 1 in accordance with the present invention, for the manufacture of at least one layer 32 on a substrate 33 for solid state thin-film batteries 100 and a substrate holder 39, both of which are arranged in a coating chamber 31. A negative pressure ΔP in relation to the mixing area 20 located in the plasma-powder-sprayer 1 can be created in the coating chamber 31 by a suction pump 60.

An ignition gas stream 13 is let into a plasma generation area 10 through an ignition gas inlet 18. From this a plasma gas stream 13 can be ignited by bombarding with energy 12 from an energy source 15. The energy source can, e.g., be an electrical voltage source. The electrical voltage source can be created by, e.g., a continuous or pulsed direct and/or alternating voltage on an active electrode 16 against the potential of the plasma-powder-sprayer 1, the substrate 33 and/or the coating chamber 31.

The plasma gas stream 13 flows from the plasma generation area 10 into a mixing area 20 spatially separated from it. At least one powder-aerosol supply line 47 is assigned for the mixing area 20 through which a powder-aerosol stream 44 can be introduced. The plasma gas stream 13 and the powder-aerosol stream 44 mix with each other in the mixing area to a plasma-powder-aerosol stream 34 that can be directed through an opening 28 of the plasma-powder-sprayer 1 onto a substrate so that the powder particles contained in it are deposited as a layer 32.

In this way the powder particles can be thermally modified at least in their physical quality. For example, the powder particles can be superficially fused or altered in their crystalline structure. To apply the temperatures and heat flows required for the modification of the powder particles during the residence time in the plasma-powder-aerosol 34, a combination of pressure or the partial pressure ratio and temperature in the plasma-powder-aerosol 34 can be adjusted. The heat flow is largely fed and regulated by the energy source 15. Pressure conditions are regulated by mass flow controllers u0, . . . , un or v0, . . . , vk of the gas components of the ignition gas stream 12 or carrier gas stream 42. The gas components are held in the respective gas reservoirs 12l, . . . , 12n or 42l, . . . , 42k. Jets for regulation of pressure and flow can additionally be designed in the ignition gas inlet 18, in the powder-aerosol supply lines 47 and/or in the opening 28. The heat input in the powder particles also depends on the geometry of the plasma-powder-sprayer 1, on the negative pressure ΔP and on the distance 38 from the plasma-powder-sprayer 1 and substrate 33. Additionally, the temperature of the powder-aerosol stream 44 can be set by a device 46 assigned to the powder-aerosol supply line 47. Furthermore, a substrate holder 39 can include a substrate heater 36. To increase the temperature, a gas mixture such as O₂ and H₂ in the plasma-powder-sprayer 1 can also be brought to a controlled exothermic reaction. To limit the in situ temperature in the plasma-powder-aerosol stream 34, a gas or gas mixture that reacts endothermally above a specific threshold temperature can be introduced. In accordance with the present invention, the introduction of liquids in the plasma-powder-sprayer 1 is avoided so that no thermal energy is lost due to evaporation. Furthermore, the substrate temperature T33 of the gas or plasma stream directed on the substrate 33 can be influenced by irradiation of light.

Furthermore, an adjusting system 50 can create a relative movement between the plasma-powder-sprayer 1 and the substrate holder 33. For instance, the substrate holder 39 can be arranged on a conveyor belt 50 or on a rotating device 50. The plasma-powder-sprayer 1 and/or substrate holder 33 can also be connected rigidly with an adjusting device 50 that can carry out any translation or rotation along or at least around the x-axis, y-axis and/or the z-axis. Due to the relative movement, structured layers 32 with three dimensional topographies can also be deposited on substrates 33. Additionally, a structuring element 37 can be introduced into the plasma-powder-aerosol stream 34, so as to partially shade out or cover the substrate 33. The structuring element 37 can be designed rigid or adjustable by the adjusting system 51.

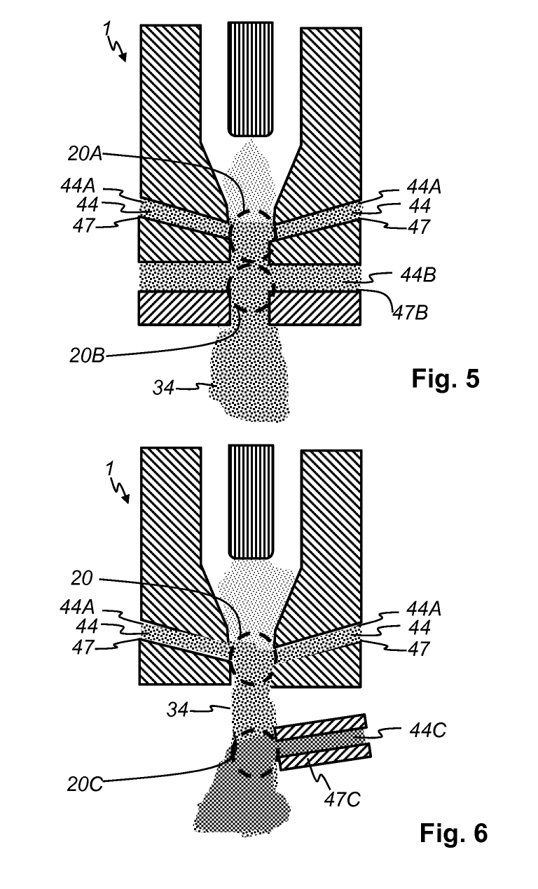

FIG. 5 and FIG. 6 show schematic sectional views of other embodiments of the plasma-powder-sprayer 1 in accordance with the present invention. In the plasma-powder-sprayer 1 depicted in FIG. 5, at least the one mixing area 20 includes a first mixing area 20A and at least a second mixing area 20B, which are spatially separated from each other and are arranged inside the plasma-powder-sprayer 1.

In the plasma-powder-sprayer 1 depicted in FIG. 6, at least the one mixing area 20 includes at least a first mixing area 20A and at least a second mixing area 20B, which are spatially separated from each other, whereby at least one more mixing area 20C of the at least a second mixing area 20B are arranged outside the plasma-powder-sprayer 1. Auxiliary material 44A, 44B, 44C can be introduced into the mixing areas 20, 20A, 20B, 20C through at least one powder-aerosol supply line 47, 47B, and 47C respectively.

### LIST OF REFERENCE NUMERALS

1 Plasma-Powder-Sprayer
10 Plasma Generation area
11 Energy
12 Ignition gas stream
12l first gas reservoir
12n n-th gas reservoir
13 Plasma stream
14 Ignition gas reservoir
15 Energy source
16 Electrode
18 Ignition gas inlets
20 Mixing area
24 Plasma-Powder-Aerosol
28 Opening
30 Coating area
31 Coating chamber
32 Layer
33 Substrate
34 Plasma-Powder-Aerosol stream
36 Substrate heater
37 Mask
38 Distance
39 Substrate holder
40 Powder dosing unit
41 Carrier gas stream
42 Carrier gas stream
42l First carrier gas reservoir
42k k-th Carrier gas reservoir
43 Powder reservoir
44 Powder-Aerosol stream
46 Device
47 Powder-Aerosol supply line
48 Powder particles
49 Plasma-Powder supply line
50 Adjusting system
60 Suction pump
70 Control unit
71 Mass flow control
100 Solid state thin-film battery
101 Current collector
102 Cathode layer
103 Electrolyte layer
104 Anode layer
105 Current collector
110 Layer sequence
P10 Ignition pressure
P20 Mixing pressure
P30 Coating pressure
P40 Dosing pressure
T10 Ignition temperature
T20 Mixing temperature
T33 Substrate temperature
D Layer thickness
v Ignition gas dosing systems
v0 Mass flow regulator
v1 First mass flow regulator
vk k-th Mass flow regulator
u Carrier gas dosing system
uo Mass flow regulator
ul First mass flow regulator
un n-th Mass flow regulator
x x-axis
y y-axis
z z-axis

What is claimed is:

1. A method for the manufacture of at least one layer (32) for solid state thin-film batteries (100) with the help of a plasma-powder-sprayer (1) with a plasma generation area (10) and with at least one mixing area (20) spatially separated from it, including the steps of:
creation of a plasma gas stream (13) from an ignition gas stream (12) in the plasma generation area (10);
creation of a powder-aerosol stream (44) from a carrier gas stream (41) from a carrier gas reservoir (42) and powder particles (48) from a powder reservoir (43), whereby the powder particles (48) are extracted under admixture of carrier gas (42) into the powder reservoir (43) in such a way that in the powder-aerosol stream (44) over and above an extraction time period, a constant mass flow dM/dt of powder particles (48) and a constant mixing ratio of powder particles (48) and carrier gas (42) is set;
introduction of the powder-aerosol stream (44) and the plasma gas stream (13) into the at least one mixing area (20), so that a plasma-powder-aerosol (24) is formed;
directing a plasma-powder-aerosol stream (34) from the at least one mixing area (20) onto a substrate (33) arranged in a coating area (30); and,
deposition of a layer (32) on a substrate (33) of powder particles (48) that are superficially fused or changed in their crystalline structure in at least one mixing area (20) and/or in the plasma-powder-aerosol stream (34) and/or in the coating area (30).

2. The method recited in claim 1, wherein the powder-aerosol stream (34) is channeled through a device that brings it to a temperature required for running the process.

3. The method recited in claim 1, wherein the substrate (33) is heated by a substrate heater (36) of a substrate holder (39).

4. The method recited in claim 1, wherein a distance (38) and/or a relative movement between the plasma-powder-sprayer (1) and the substrate (33) is set by an adjusting system (50).

5. The method recited in claim 1, wherein for deposition of structured layers (32) onto the substrate (33), a structuring element (37) is brought onto or over the substrate (33) statically or by the adjusting system (50) in the plasma-powder-aerosol stream (34).

6. The method recited in claim 1, wherein the substrate (33) is introduced into a coating chamber (31) in which the plasma-powder-aerosol stream (34) is introduced, wherein a negative pressure (ΔP) against the mixing area (20) is created in the coating chamber (31) with the help of a suction pump (60).

7. The method recited in claim 1, wherein in at least one mixing area (20) and/or in at least another mixing area (20A, 20B) one auxiliary material (44A, 44B) each is introduced into the plasma-aerosol stream (34), so that the powder particles (48) at least partly are coated with auxiliary material (44A, 44B), whereby the at least one other mixing area (20A, 20B) lies inside or outside the plasma-powder-sprayer (1) and in the plasma-powder-aerosol stream (34).

8. The method recited in claim 1, wherein the powder particles (48) for the manufacture of a cathode layer (102) consist primarily of a lithated oxide of one or more transition metals.

9. The method recited in claim 1, wherein the layer (32) is built up of powder particles (48) that are thermally activated in the plasma-aerosol stream (34) and are unchanged with respect to their chemical stoichiometry and their particle size distribution, and whereby the porosity of the layer (32) is set by the rate of deposition, the temperature of the substrate (T33) and/or the particle size distribution of the powder particles (48).

10. The method recited in claim 1, wherein the ignition gas stream (12) and/or the carrier gas stream (42) consist of a chemically inert gas or nitrogen with an admixture of oxygen, hydrogen and/or a carbonaceous gas.

11. The method recited in claim 1, wherein the powder particles (43) are thermally activated with reference to their electrochemical properties, and/or whereby the chemical stoichiometry of oxidic powder particles (48) is obtained by admixing of oxygen in the ignition gas stream (12) and/or the carrier gas stream (42).

12. The method recited in claim 1, wherein at a substrate temperature (T33) under 240° C. and/or a mixing temperature (T20) of 350° C. to 750° C. in at least one mixing area (20) and partial pressures of oxygen tuned to the mixing temperature (T20) and total pressure (P20) powder particles (48) of lithium cobalt dioxide are thermally altered in their high temperature phase.

13. A solid state thin-film battery (100) in which at least one layer (32) of said battery is manufactured from powder particles (48) by the method of A method for the manufacture of at least one layer (32) for solid state thin-film batteries (100) with the help of a plasma-powder-sprayer (1) with a plasma generation area (10) and with at least one mixing area (20) spatially separated from it, including the steps of:
creation of a plasma gas stream (13) from an ignition gas stream (12) in the plasma generation area (10);
creation of a powder-aerosol stream (44) from a carrier gas stream (41) from a carrier gas reservoir (42) and powder particles (48) from a powder reservoir (43), whereby the powder particles (48) are extracted under admixture of carrier gas (42) into the powder reservoir (43) in such a way that in the powder-aerosol stream (44) over and above an extraction time period, a constant mass flow dM/dt of powder particles (48) and a constant mixing ratio of powder particles (48) and carrier gas (42) is set;
introduction of the powder-aerosol stream (44) and the plasma gas stream (13) into the at least one mixing area (20), so that a plasma-powder-aerosol (24) is formed;
directing a plasma-powder-aerosol stream (34) from the at least one mixing area (20) onto a substrate (33) arranged in a coating area (30); and,
deposition of a layer (32) on a substrate (33) of powder particles (48) that are superficially fused or changed in their crystalline structure in at least one mixing area (20) and/or in the plasma-powder-aerosol stream (34) and/or in the coating area (30).
